(19) United States
(12) Patent Application Publication
(10) Pub. No.: US 2008/0313269 A1
(43) Pub. Date: Dec. 18, 2008

(54) Remoting of Console Operating in a Multi-Session Environment

(75) Inventors: Wilhelm R. Schmieder, Issaquah, WA (US); Carl Carter-Schwendler, Kirkland, WA (US); Kestutis Patiejunas, Sammamish, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/762,577

(22) Filed: Jun. 13, 2007

(51) Int. Cl. G06F 15/16; G06F 15/173; G06F 17/00

(52) U.S. Cl. 709/203; 709/224; 709/227; 726/12

(57) ABSTRACT

Apparatus and methods for remoting of a console operating in a multi-session environment are described. A server process creates one or more proxy processes associated with login sessions. The proxy processes are controlled and managed by a session manager. The server manager can be instrumented to process the graphical information. The graphical information is eventually utilized for creating a visual representation on a client device as the output. The client device includes a client-side process or a client-side proxy, for processing information sent by the server, which is finally used for rendering the associated visual representation on the client device.

### BACKGROUND

Systems and methods are currently available that allow remoting of one or more services resident on a centrally located computing device such as a server computing device or server. The server for example, can host a number of services and applications. These applications can be accessed by other users (through remote computing devices) through one or more systems. Examples of such systems include Terminal Service™ system by the Microsoft® Corporation. A multi-session environment, such as one implemented using Terminal Service™ system, enables multiple users to access resources and application that are hosted on a central device (e.g., server). Therefore, users with proper credentials can access the server and services by creating a login session. A login session allows a user to access the server and associates each login session with its own user. The terminal from which the user accesses the server can be referred to as a console or local terminal. While accessing the server, the login session created by a user is associated with the particular console. In such a case, only one session can be associated with a particular console at any given instance.

### SUMMARY

This summary is provided to introduce concepts relating to remoting of a console operating in a multi-session environment. These concepts are further described below in the detailed description. This summary is not intended to identify essential features of the claimed subject matter, nor is it intended for use in determining the scope of the claimed subject matter.

In an embodiment, a proxy process is created and managed by a service process and associates the proxy process with login sessions of one or more consoles.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an exemplary system for remoting of a console operating in a multi-session environment.

FIG. 2 illustrates an exemplary server-based device.

FIG. 3 illustrates an exemplary client device.

FIG. 4 illustrates interactions between a server computing device and client device for remoting of a console operating in a multi-session environment.

FIG. 5 illustrates a flowchart for remoting of a console operating in a multi-session environment.

FIG. 6 illustrates a flowchart for remoting of a console operating in a multi-session environment.

FIG. 7 illustrates a flowchart for communicating input commands from client device to the intended session in a multi-session environment.

### DETAILED DESCRIPTION

Systems and methods for remoting a console operating in a multi-session environment are described. In a multi-session environment, one or more users can access resources and applications hosted on a centralized computing device, such as a server. The users access the resources on the server in a session, unique to the user. Multiple users can log on to the server through a local or remote console. Typically, one user can log in through a physical local console. A console can be generally considered to include hardware, such as a keyboard, display device, and so on. Generally, each session is associated with the console on which it is being run, and replicates a desktop environment similar to a desktop environment made available as if users were working directly on the locale console. It is to be understood that the session can be implemented using instruction codes, for example, codes of an operating system, and known network and remoting protocols.

Remoting of the session may include the transfer of graphical information associated with the session. The graphical information is used for creating a visual representation associated with the graphical information, onto a client device accessing the server. The abstracted graphical information is remoted to a remote client where the transferred (e.g., serialized for network transfer) of graphical information is rendered onto the respective display device as an output. Additionally, input commands from the remote client can be processed and sent to the server. The server converts the processed data into operating system specific input instruction format and injects input commands into instruction code associated with the session.

A server process creates one or more proxy processes associated with respective login sessions. The proxy processes are controlled and managed by a service process. Generally, a server process can be an instance of execution of one or more server components that interact with one or more user processes. The server process can be instrumented to process the graphical information. The graphical information is eventually utilized for creating a visual representation on a client device as the output. The client device includes a client-side process for processing information sent by the server, which is finally used for rendering the associated visual representation on the client device. The client-side process manages the communication of input commands from the client devices to the server process or the proxy process. The communicated commands are then merged within the active session, affecting the change in conformance with the input commands.

The remoting of data from one computing device to other computing devices can be accomplished using techniques known in the art. Examples of such techniques include systems based on Remote Desktop Protocol (RDP), and services like such as Terminal Service™ system by the Microsoft® Corporation.

While aspects of described systems and methods for remoting of a console operating in a multi-session environment can be implemented in any number of different computing systems, environments, and/or configurations, the embodiments are described in the context of the following exemplary system architecture(s).

### An Exemplary System

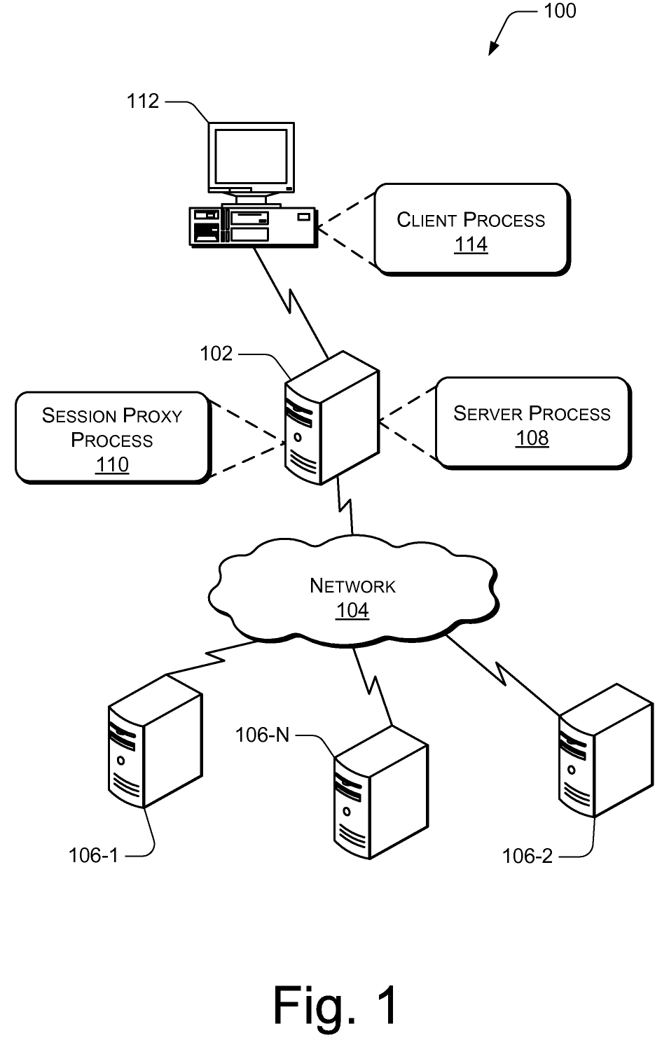

FIG. 1 shows an exemplary system 100 for remoting a console operating in a multi-session environment. The system 100 includes a server computing device or server 102 communicating through a network 104 with one or more consoles 106-1 to 106-N which can be collectively referred to as consoles 106. In an implementation, system 100 can be a company network, including a number of office PCs, various servers, and other computing-based devices spread throughout several countries. Alternately, in another possible implementation, system 100 can include a home network with a limited number of PCs belonging to a single family.

System 100 may be or be similar to a Terminal Service™ system by the Microsoft® Corporation, wherein multiple consoles 106 access applications installed or hosted on server 102. Consoles 106 desiring to access applications hosted on server 102 interact with the application through a session. The session displays an output, on output device of the client (e.g., console 106), in conformance with the visual output that would have been displayed, had the user been accessing the server directly. This enables a user on any one or more of consoles 106 to access applications hosted on server 102. It is to be understood that access may be provided for a definite number of applications or for all applications hosted on server 102.

In an implementation, access is provided to a user to a physical console, and to one user. In the event that multiple users attempt to access the physical console an arbitration process may be implemented to only one user to interact with the physical console or allow multiple users to interact with the same console at the same time.

Applications and services hosted on server 102 are accessible by consoles 106 by using remote client access system such as Terminal Services™ system. Consoles 106 can be coupled to each other or to server 102 in various combinations through a wired and/or wireless network, including a LAN, WAN, or any other networking technology known in the art.

Server computing device 102 includes server process 108 and session proxy process 110. Server process 108 includes among other functions, functions that create and manage one or more proxy processes and associate them with their respective login sessions. The proxy processes can be considered to be processes that enable interaction between one or more user processes, such as originating from consoles 106 or client device 112, and the processes that are present on server 102. The providing of access for users, like client device 108 or consoles 106, is also accompanied by rendering the appropriate output at one or more client device 108 or consoles 106. The rendering is performed in accordance with graphics information, based on which output is created at consoles 106. Session proxy process 110 also manages the processing of such graphical information and communicating the information to one or more of client device 108.

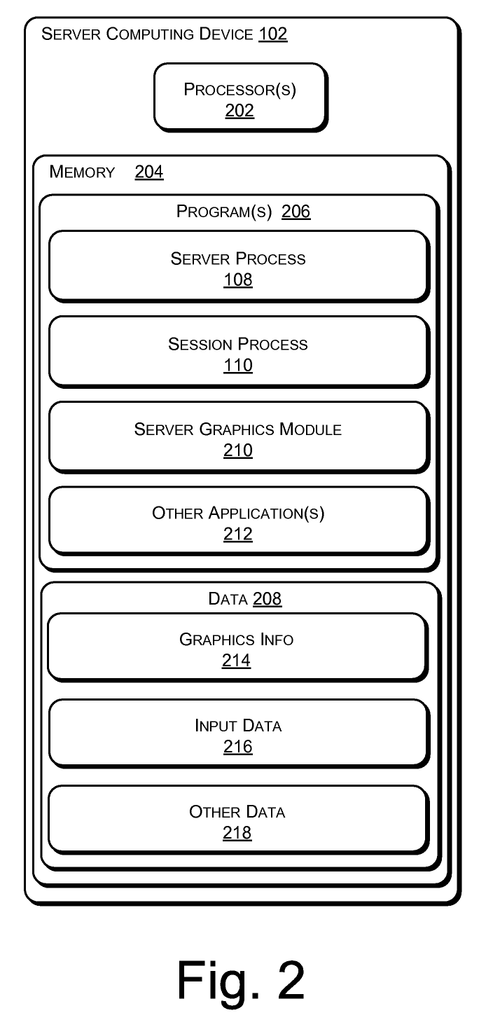

Session proxy process 110 abstracts information associated with the visual representation to be displayed. The abstracted information is communicated by session proxy process 110 to server process 108 in server computing device 102. Upon processing, server computing device 102 sends the abstracted information across to client device 108, which renders a visual output on its display device, in conformance with the abstracted information. In addition, a user initiated input, for example a key press or mouse click can be communicated to server process 108 and eventually to session proxy process 110 in server 102. The manner in which the remoting of console is implemented is further described in reference to FIGS. 2-4. It is to be appreciated that the description as presented, indicates a single client device 112; however, the same description is also applicable to multiple client devices 112.

### Exemplary Server Computing Device

FIG. 2 illustrates relevant exemplary components of server computing device 102. Server computing device 102 can include one or more processor(s) 202 and memory 204. Processor(s) 202 may include microprocessors, microcomputers, microcontrollers, digital signal processors, central processing units, state machines, logic circuitries, and/or any devices that manipulate signals based on operational instructions. Among other capabilities, processor(s) 202 are configured to fetch and execute computer-readable instructions stored in memory 204.

Memory 204 can include any computer-readable medium known in the art including, for example, volatile memory (e.g., RAM) and/or non-volatile memory (e.g., flash, etc.). As illustrated in FIG. 2, memory 204 also can include program(s) 206 and data 208. Program(s) 206 include, for example, session proxy process 110, session proxy process 110, server graphics module 210, and other application(s) 212. Other application(s) 212 include programs that supplement applications on any computing based device such as word processor applications, spreadsheet applications, and such. Data 208 may include, for example, graphics info 214, input data 216 and other data 218.

As discussed above server process 108 among other functions creates and manages proxy processes and associates them with their respective login session. On detecting when a new session becomes attached to the physical console, server process 108 initiates the creation of one or more proxy processes that are associated with the session. The proxy processes that are created, through well known and/or available application program interfaces (API) such as “CreateProcessAsUser” (e.g., APIs available through the Microsoft® Windows® operating system), would function within the instance of the existing session.

Server process 108 processes graphical information obtained from session process 110. Session proxy process 110 abstracts graphical information from a session that is associated with one or more consoles 106. The graphical information collected is associated with the visual output that would have been rendered onto the display device of consoles 106 as displayed on a physical console. In one implementation, instances of session proxy process 110 can also be present on consoles 106.

The graphical information that is abstracted is stored in graphics info 214. Graphical information may include a bitmap corresponding to the desktop representation at a point in time. It is to be understood, that the desktop representation can be more complex and include a sequence of graphics primitives like bitmaps, lines, curves, text that can provide an accurate representation of the desktop at a point in time. Graphics info 214 abstracted by session proxy process 110 is then communicated to server process 108. Server process 108 processes graphics info 214 using a specific protocol. In an implementation, server process 108 encodes graphics info 214 using the specific protocol (e.g., RDP protocol). The encoding procedure converts graphics info 214 in a format that can be rendered by a computing based device. In another possible implementation, the specific protocol is stored in other data 218.

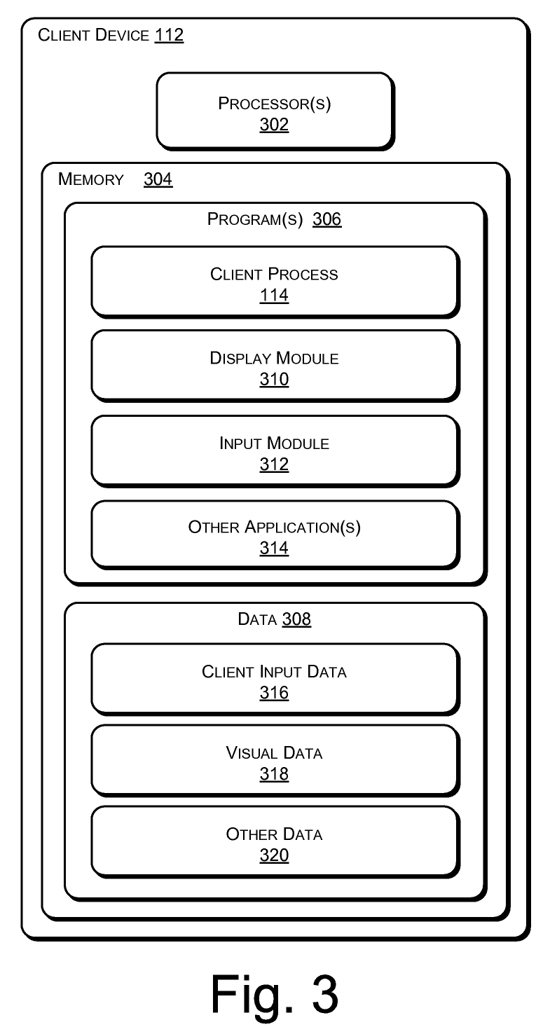

Server process 108 sends the encoded graphics info 214 to client device 108. Client device 108 renders a visual output in conformance with the encoded graphics info 214 onto the display unit of client device 108. In addition, input commands from client device 108 are processed and executed on server computing device 102 and a corresponding visual output is displayed on client device 108. The input commands are stored in input data 216. These and additional concepts are further described in FIG. 3.

### Exemplary Client Device

FIG. 3 illustrates relevant exemplary components of client device 112. Client device 112 can include one or more processor(s) 302 and memory 304. Processor(s) 302 may include microprocessors, microcomputers, microcontrollers, digital signal processors, central processing units, state machines, logic circuitries, and/or any devices that manipulate signals based on operational instructions. Among other capabilities, processor(s) 302 are configured to fetch and execute computer-readable instructions stored in memory 304.

Memory 304 can include computer-readable medium known in the art including, for example, volatile memory (e.g., RAM) and/or non-volatile memory (e.g., flash, etc.). As illustrated in FIG. 3, memory 304 also can include program(s) 306 and data 308. Program(s) 306 include, for example, client process 114, display module 310, input module 312, and other application(s) 314. Other application(s) 314 include programs that supplement applications such as word processor applications, spreadsheet applications, etc. Data 308 include, for example, client input data 316, visual data 318, and other data 320.

Client process 114 receives the processed data from session proxy process 110. In an implementation, the data received from session proxy process 110 is the encoded form of graphics info 214. The encoded graphics info 214 is decoded by client process 114 into a data format that can be rendered onto client device 108. In an implementation, the decoded data is stored in visual data 318. Visual data 318 includes information that is associated with a visual representation that corresponds to the output to be displayed. Visual data 318 includes information characterized by one or more attributes. These attributes define the visual characteristics of the output to be displayed. For example, the visual data 318 can be rendered onto client device 108 in a GDI redirection.

Once visual data 318 is created, display module 310 renders the output on client device 108 in conformance with the characteristics of visual data 318. In addition, user of client device 108 interacts with the resources and applications installed on server computing device 102. Generally, the interactions are performed through various input devices, such as a keyboard, a mouse, and similar devices. Upon such user input, a corresponding change may also be affected on the display unit of client device 108. To implement the change, input module 312 captures the input commands entered by a user at client device 108 and encodes data associated with input commands. The encoded data is stored in client input data 316.

Client process 114 sends the client input data 316 to session proxy process 110. Client input data 316 is transmitted over to session proxy process 110 in server computing device 102 using known network protocols. Client input data 316 is then decoded by session proxy process 110. The decoded client input data 316, is stored, in one implementation, in input data 216 of server computing device 102.

The decoded client input data 316 stored in input data 216 is communicated to proxy or session process 112 associated with the session in consideration. The decoded client input data 316 is then injected into the operating system of server computing device 102. Operating system APIs may allow a program (i.e., an application) to simulate input as it would come from the keyboard, where “SendInput” is an example of such an API. The same result can also be achieved through other mechanisms such as installing virtual keyboard and mouse drivers. Once the decoded client input data 316 is injected a corresponding change is affected at the server end which is in accordance with the input commands given at client device 108. The interactions between session proxy process 110 and session process 112 allow the transition between the transmitting stage and the injecting stage to proceed seamlessly.

### Exemplary Method(s)

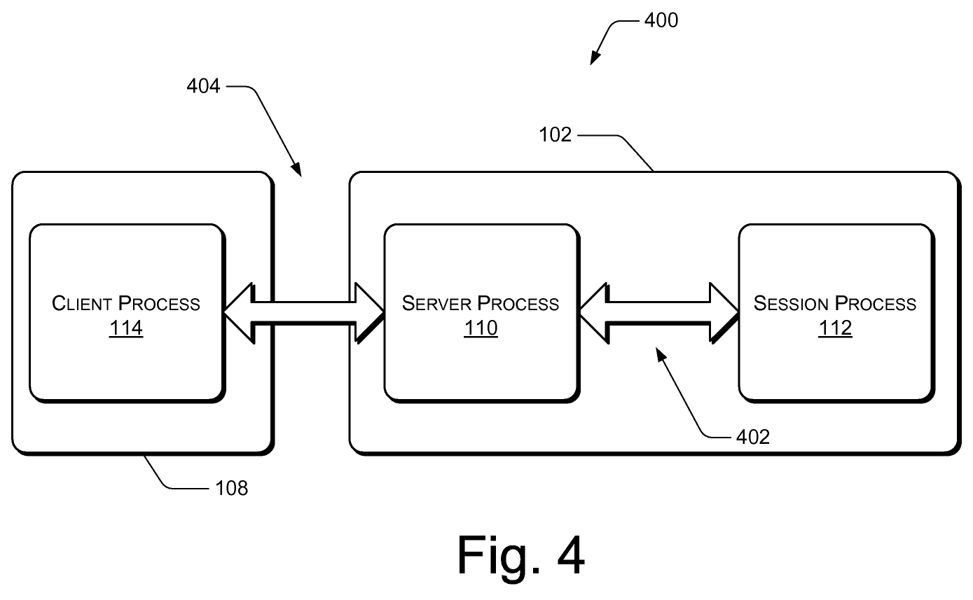

Exemplary methods for remoting of a console operating in a multi-session environment are described with reference to FIGS. 1 to 3. FIG. 4 shows a series of exemplary interactions between the server 102 and client device 108 for remoting of a console operating in a multi-session environment. The exemplary interactions may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices. The interaction 402 depicts the exchange of information between server process 108 and session proxy process 110. The interaction between server 102 and client device 112, and more specifically server process 108 and client process 114 is illustrated through interaction 404.

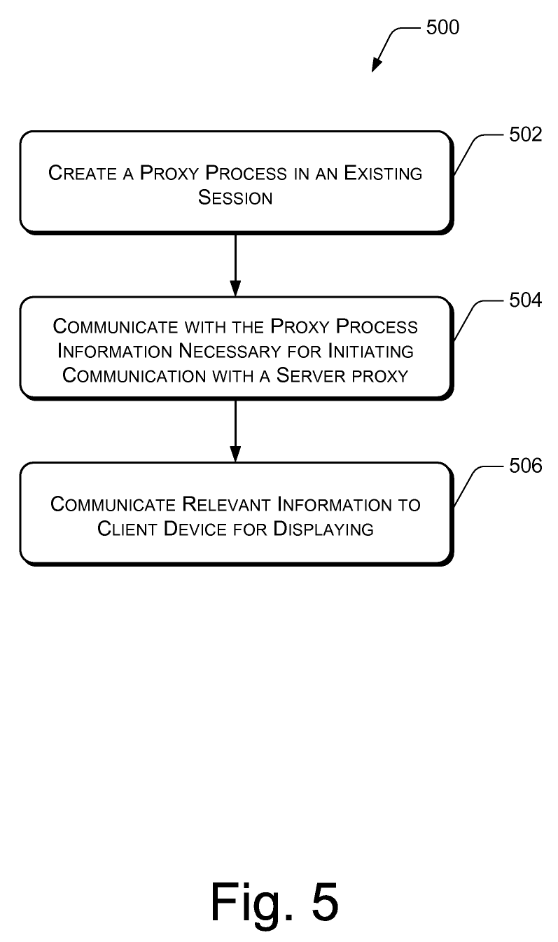

FIG. 5 illustrates an exemplary method 500 for remoting of a console operating in a multi-session environment. The order in which the method is described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the method can be implemented in any suitable hardware, software, firmware, or combination thereof.

At block 502, a proxy process is created in an existing session. The proxy process can be considered to be instances of one or more components on a server, such as server computing device 102. For example, server process 108 in server computing device 102 seeks an existing session. A proxy may be created in the session that is attached to the console, when it is detected that the session became attached to the console. In other implementations, it may also be possible create proxy processes in sessions and interact only with the proxy process that is hosted in the session that is attached to the console. The one or more proxy processes are managed by session process 112.

At block 504, server process and the proxy processes created by the server in the existing session, transfer information to each other to initiate communication between the server process and the proxy process. For example, server process 108 establishes a communication link to session proxy process 110. Desktop graphics data may be available in memory corresponding to that session. In an implementation, the “SendInput” API can inject input only in the session where the process that calls it is executed. The communication link established by server process 108 is used for exchanging information associated with input data, graphics data, session management data, etc. In an implementation, such information can be gathered by session process 112. The interaction between session proxy process 110 and session process 112 may be described by interaction 402 of FIG. 4. The interaction 402 depicts the exchange of information between server process 108 and session proxy process 110. The exchange of the information is seamless as represented by interaction 402.

At block 506, the relevant information for display is communicated to one or more client devices (e.g., client device 112) that are accessing services or applications hosted on a server computing device 102. For example, server process 108 redirects the relevant display information to client device 112. The display information is utilized for rendering a visual output at the display unit of client device 112. Various other implementations for representing the interactions between the various processes, are further provided.

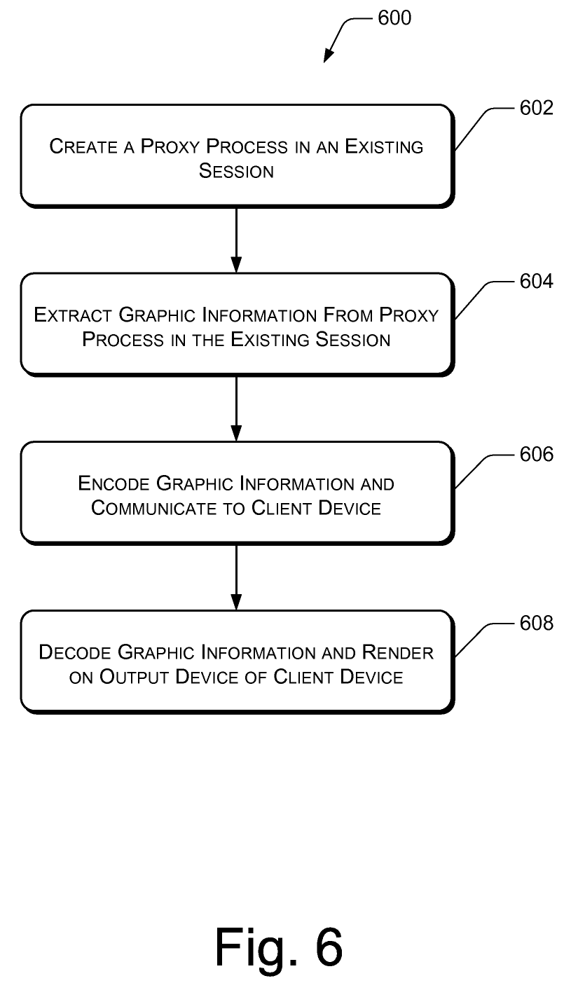

FIG. 6 illustrates an exemplary method 600 for remoting of a console operating in a multi-session environment. The order in which the method is described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the method can be implemented in any suitable hardware, software, firmware, or combination thereof.

At block 602, a proxy process is created in an existing session. The proxy process can be considered to be any instances of one or more components on a server, for example server computing device 102. For example, server process 108 in server computing device 102 seeks an existing session. On detecting an existing session, server process 108 creates one or more proxy process, such as session process 112, in that session. Session proxy process 110 is unique for a certain session.

At block 604, graphical information associated with the proxy process is abstracted from the session. Each session has one or more associated proxy processes created by the server process 108. In an implementation, proxy processes created by service process 108. Session proxy process 110 extracts graphics info 214 associated with the proxy process associated with a given session. As indicated previously, graphics info 214 includes data associated with the output that would have been rendered at consoles 106. The visual representation that is finally displayed as output is in accordance with graphics info 214.

At block 606, graphical information associated with the proxy processes of a session is encoded and communicated to a client device. The encoded information serves as basis for the rendering of the visual representation in accordance with the associated information. For example, server process 108 encodes the graphics info 214 received from session proxy process 110. The encoding operation may be performed by a module present in other application(s) 212. The encoded information (i.e., encoded form of graphics info 214 is sent to client device 112 through known network protocols).

The interaction between server 102 and client device 112, and more specifically server process 108 and client process 114 is illustrated through interaction 404 of FIG. 4. Encoded information from server process 108 is transferred to client process 114, where it will be utilized for rendering of an output display, according to the encoded information.

At block 608, the encoded graphical information received from the server process is decoded and rendered onto the client device. For example, client process 114 on receiving the encoded graphics info 214 from server process 108, instructs display module 310 to decode the encoded graphics info 214. The decoded data is stored in visual data 318. Display module 310 then uses the visual data 318 to render a visual display on client device 112, which is in accordance with visual data 318.

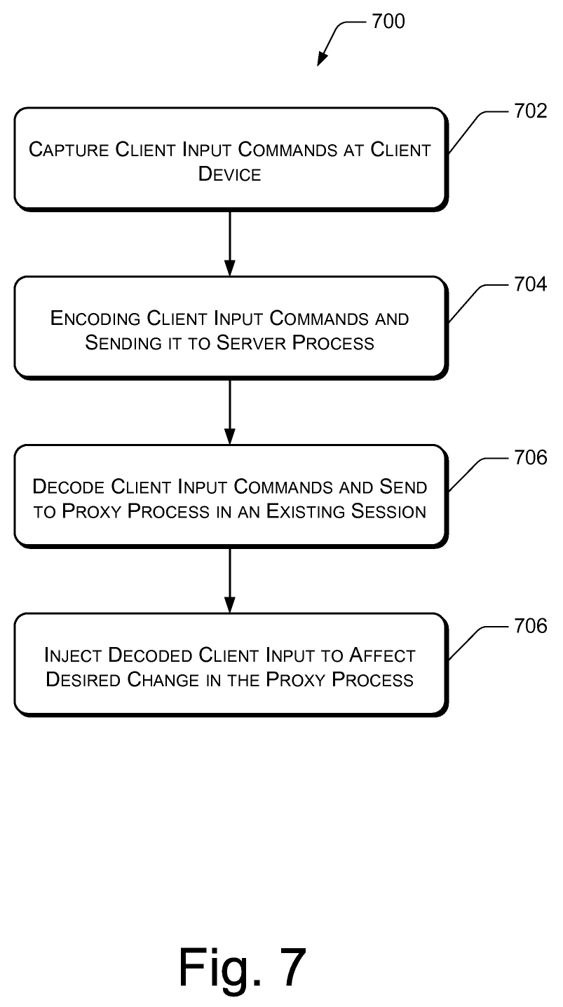

FIG. 7 illustrates an exemplary method 700 for communicating input commands from client device to the intended session in a multi-session environment. The order in which the method is described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the method can be implemented in any suitable hardware, software, firmware, or combination thereof.

At block 702, input commands from a client device are captured. For example, client process 114 in client device 112 captures the input commands entered by a user, by storing associated data generated with each input command. Data associated with the input commands can be stored in client input data 316. Examples of such input commands include, but are not restricted to, keyboard strikes, mouse-clicks, and so on.

At block 704, the input commands captured from the client devices is encoded and sent to a server. For example, data associated with the input commands, stored as client input data 316 is encoded by an encoding module in other application(s) 314. In another implementation, the encoding procedure is performed by client process 114. The encoded user input commands and associated data can be stored in client input data 316.

The interaction between the client process 114 and server process 108, and in general, the interaction between the client device 112 and server computing device 102 is illustrated by interaction 404 in FIG. 4. The interaction results in the transfer of encoded data that is associated with the input commands entered by a user, on client device 112. In yet another implementation, the encoded data can be transferred to server process 108 using known communication techniques.

At block 706, the encoded data received from the client device is decoded. The decoded data is sent to the proxy process of an existing session. For example, server process 108 on receiving the encoded client input data 316 from client device 112 decodes the encoded client input data 316 and saves the decoded data in input data 216. The decoded data or input data 216 is fetched by session proxy process 110 and instructed to be sent to proxy process of the session. The decoder process may send data straight to the proxy; however, there may also be a component in that decoding (or service) process that monitors sessions and communicates with the right proxy.

At block 708, the decoded client input is injected by the proxy process using input instructions specific to the operating system. For example, session proxy process 110 injects the decoded input commands and associated data into the operating system of server computing device 102. The proxy process injects the input. The operating system completes any other steps necessary for the input to be interpreted and sent to the applications running in the session.

### CONCLUSION

Although embodiments for remoting of a console operating in a multi-session environment have been described in language specific to structural features and/or methods, it is to be understood that the subject of the appended claims is not necessarily limited to the specific features or methods described. Rather, the specific features and methods are disclosed as exemplary implementations for remoting of a console operating in a multi-session environment.

What is claimed is:

1. A server computing device comprising:
a memory;
one or more processors operatively coupled to the memory;
a service process in the memory, wherein the server process manages proxy processes and associates the proxy processes with login sessions that are connected to one or more physical consoles.

2. The server computing device of claim 1, wherein the server process detects existing login sessions and initiates the creating of one or more proxy processes associated with the detected login sessions.

3. The server computing device of claim 1 further comprising a session process that abstracts graphical information from a login session associated with one or more consoles.

4. The server computing device of claim 3, wherein the graphical information is associated with visual output that may be rendered on display devices of the one or more consoles.

5. The server computing device of claim 3, wherein a session monitor process is associated with the one or more physical consoles.

6. The server computing device of claim 3, wherein the graphical information is stored in the memory.

7. The server computing device of claim 3, wherein the server process encodes the graphical information into a format that can be rendered by a computing based device.

8. The server computing device of claim 1 further comprising input data in the memory, wherein the input data stores input commands from a computing based device.

9. A client computing device comprising:
a memory;
one or more processors operatively coupled to the memory;
a client process that receives processed data from a server computing device as encoded graphics information which is decoded by the client process and stored as visual data characterized by one or more attributes.

10. The client computing device of claim 9, wherein the attributes define visual characteristics of an output to be displayed.

11. The client computing device of claim 9, wherein the client process sends client input data to a server process on the server computing device.

12. The client computing device of claim 9 further comprising a display module that renders output on the client computing device in conformance with the visual data.

13. The client computing device of claim 9 further comprising an input module that captures input commands entered by a user at the client computing device.

14. A method for remoting a console operating in a multi-session environment comprising:
creating a proxy process in a session of the multi-session environment;
transferring information between the proxy process and a server process to establish a logical link as to the console and a server computing device which includes the server process; and
transferring information for display to one or more client computing devices accessing services from the server computing device.

15. The method of claim 14, wherein the creating is performed when an existing session is detected.

16. The method of claim 14 further comprising abstracting graphical information associated with the session by the proxy process.

17. The method of claim 14 further comprising encoding graphical information from the server process, wherein the encoded graphical information is decoded at one or more of the client computing devices.

18. The method of claim 14 further comprising capturing input commands from the one or more client computing devices.

19. The method of claim 18, wherein the input commands are encoded and sent to the server computing device.

20. The method of claim 18 further comprising injecting the client input into instruction code of an operating system of the server computing device.
